(19) United States
(12) Patent Application Publication
(10) Pub. No.: US 2008/0244868 A1
(43) Pub. Date: Oct. 9, 2008

(54) Hinge with multiple stay positions

(75) Inventor: Chung-Yi Lin, Shulin City (TW)

Correspondence Address: POSZ LAW GROUP, PLC, 12040 SOUTH LAKES DRIVE, SUITE 101, RESTON, VA, 20191, US

(73) Assignee: SHIN ZU SHING CO., LTD., Shulin City (TW)

(21) Appl. No.: 11/730,602

(22) Filed: Apr. 3, 2007

(51) Int. Cl. E05D 5/12

(52) U.S. Cl. 16/380

(57) ABSTRACT

A hinge has a pintle with a flange, a base disk having a mounting hole mounted securely around the pintle and multiple positioning holes formed concentrically around the mounting hole, a positioning disk abutting a side of the base disk and having a limiting hole mounted securely around the pintle and protrusions protruding from the positioning disk and selectively engaging with the positioning holes and a fastener mounted on the pintle to hold the base disk and the positioning disk on the pintle. A frame and a supporting stem of an electronic photo frame can be respectively mounted securely on a front and rear end of the pintle, so that the supporting stem can be rotated to position at multiple stay positions which are distributed at a circular route parallel to the frame for selectively erecting the electronic photo frame in vertical type or horizontal type.

### BACKGROUND OF THE INVENTION

1. Field of the Invention

The present invention relates to a hinge and more particularly to a hinge that is suitable for use in an electronic photo frame and provides multiple stay positions for selectively erecting the electronic photo frame in vertical type or horizontal type.

2. Description of Related Art

A conventional electronic photo frame has a frame, a screen, a hinge and a supporting stem. The frame is rectangular and has a front side, a rear side, two opposite short edges and two opposite long edges. The screen is mounted on the front side of the frame for displaying static or active digital images. The hinge in accordance with the prior art is mounted on the rear side of the frame and has two leafs. A first leaf of the hinge is mounted securely on the rear side of the frame. A second leaf of the hinge can be pivoted relative to the first leaf and held at a specific included angle relative to the first leaf. The supporting stem has a proximal end and a distal end. The proximal end of the supporting stem is mounted securely on the second leaf of the hinge. The distal end of the supporting stem extends toward one of the short edges or one of the long edges of the frame. Thus, the supporting stem can be pivoted relative to the frame through the hinge and held at a specific included angle relative to the frame. The distal end of the supporting stem and the short edge or the long edge of the frame toward which the distal end of the supporting stem extends stand on a flat surface to erect the electronic photo frame and keep the screen inclined at a desired angle of view to display the digital images.

If the supporting stem extends toward a short edge of the frame, the electronic photo frame can stand on a flat surface with the short edge of the frame and the distal end of the supporting stem to be erected in vertical type. If the supporting extends toward a lone edge of the frame, the electronic photo frame can stand on a flat surface with the long edge of the frame and the distal end of the supporting stem to be erected in horizontal type. However, a rotational axle of the leafs of the hinge is parallel to the short edge or the long edge of the frame, so the distal end of the supporting stem is limited to rotate along a circular route transverse to the frame. Even though the distal end of the supporting stem can be rotated to any position at a circular route, the electronic photo frame is still unable to be selectively erected in vertical type or horizontal type.

### SUMMARY OF THE INVENTION

The primary objective of the present invention is to mitigate or obviate the aforementioned problem of the conventional hinge to provide multiple stay positions for the supporting stem of an electronic photo frame and to selectively erect the electronic photo frame in vertical type or horizontal type.

The hinge in accordance with the present invention is adapted to be connected between a frame and a supporting stem of an electronic photo frame and has a pintle, a base disk, a positioning disk, at least one spacer and a fastener. The pintle has a flange formed on and protruding radially from an outer wall of the pintle. The base disk has a mounting hole mounted securely around the pintle and multiple positioning holes formed concentrically around the mounting hole in the base disk.

The positioning disk abuts a side of the base disk and having a limiting hole mounted securely around the pintle and protrusions protruding from the positioning disk and selectively engaging with the positioning holes in the base disk. The at least one spacer mounted around the pintle to provide a compressive resilience. The fastener is mounted on the pintle to hold the base disk, the positioning disk and the at least one spacer on the pintle against the flange of the pintle.

The positioning disk can be rotated relative to the base disk, and the protrusions can selective engage with different positioning holes. So, the supporting stem can be rotated to position at multiple stay positions which are distributed at a circular route parallel to the frame. Accordingly, the supporting stem can be selectively rotated toward a short edge or a long edge of the frame to erect the electronic photo frame in vertical type or horizontal type.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge in accordance with the present invention;

FIG. 2 is a rear view in partial section of the hinge in FIG. 1;

FIG. 3 is a perspective view of an electronic photo frame with the hinge in FIG. 1;

FIG. 4 is an enlarge exploded view of the electronic photo frame in FIG. 3;

FIG. 5 is a rear view of the electronic photo frame in FIG. 3 with a supporting stem being rotated to 6 o'clock;

FIG. 6 is side view of the electronic photo frame in FIG. 3 with a frame being erected uprightly;

FIG. 7 is a rear view of the electronic photo frame in FIG. 3 with a supporting stem being rotated to 7 o'clock;

FIG. 8 is side view of the electronic photo frame in FIG. 5 with a frame being erected inclined; and

FIG. 9 is a perspective view of the electronic photo frame in FIG. 3 with a frame being erected in vertical type.

### DETAILED DESCRIPTION OF THE PREFERRED EMBODIMENT

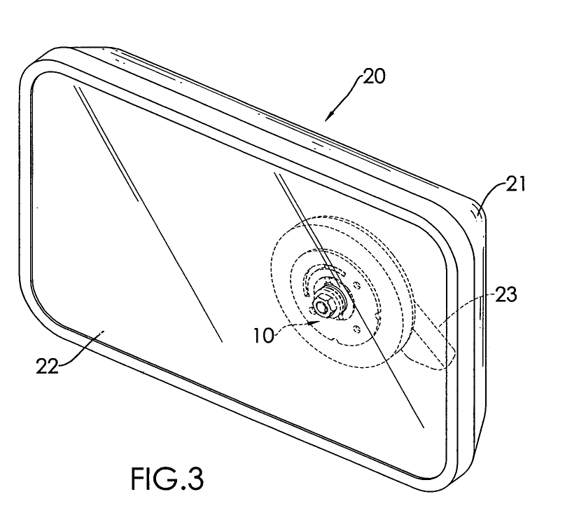

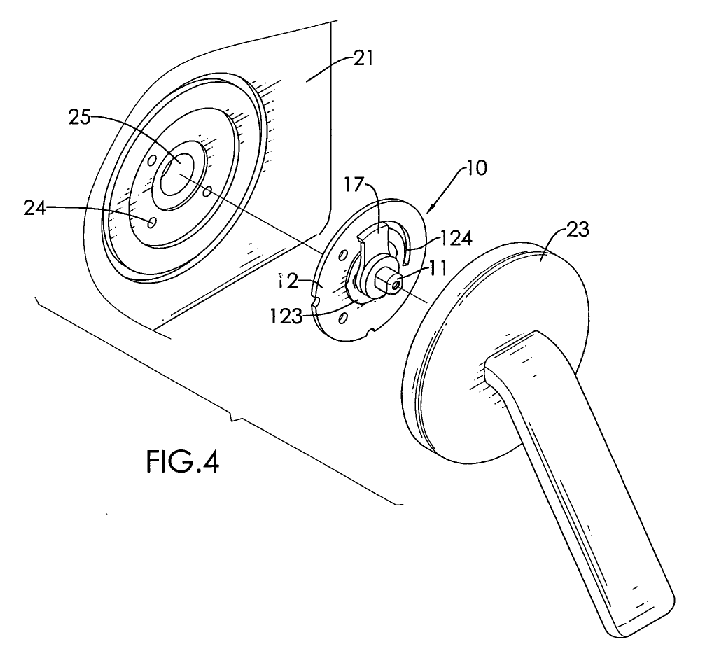

With reference to FIGS. 3 and 4, an electronic photo frame (20) has a frame (21), a screen (22), a hinge (10) and a supporting stem (23). The frame (21) is rectangular and has a front side, a rear side, two opposite short edges, two opposite long edges, a mounting cavity (25) and multiple securing holes (24). The mounting cavity (25) is formed in the rear side of the frame (21). The securing holes (24) are formed in the rear side of the frame (21) around the mounting cavity (25). The screen (22) is mounted on the front side of the frame (21) for displaying static or active digital images.

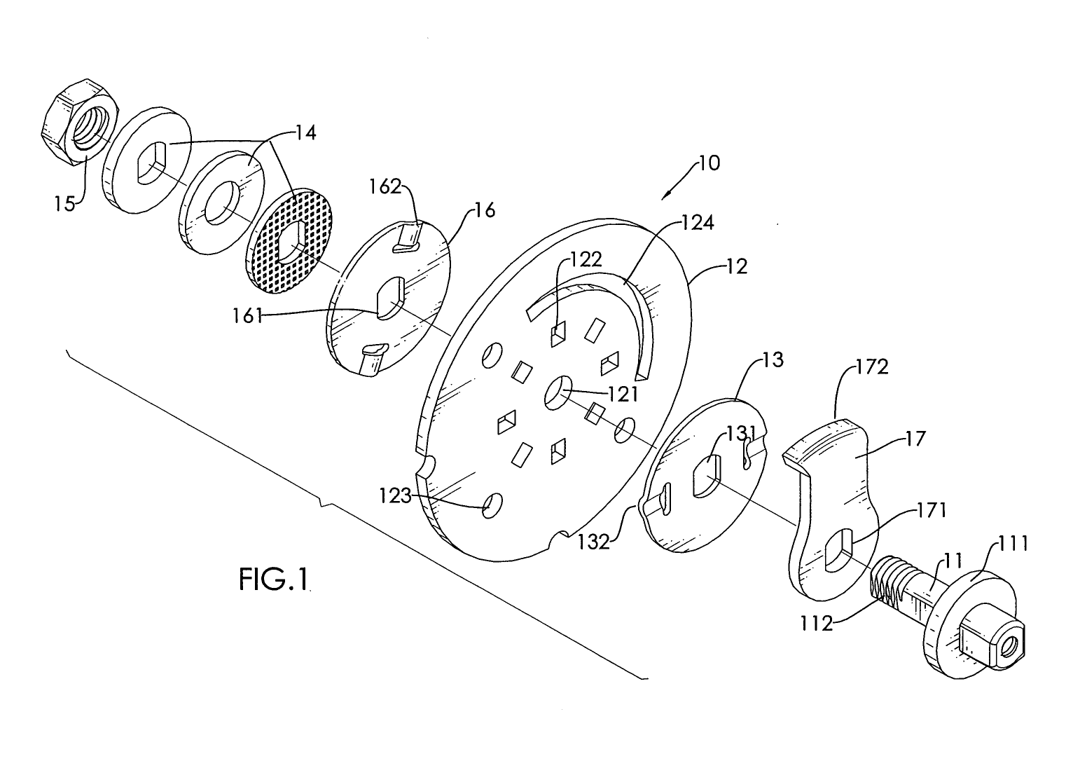

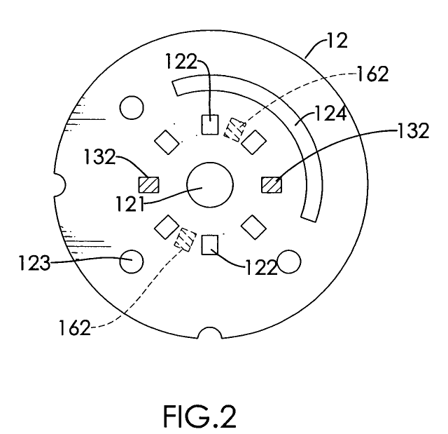

With further reference to FIGS. 1 and 2, the hinge (10) in accordance with the present invention is mounted on the rear side of the frame (21) and comprises a pintle (11), a base disk (12), a first positioning disk (13), a second positioning disk (16), at least one spacer (14), a limiting member (17) and a fastener (15).

The pintle (11) has a cross-section, a front end, a rear end, an outer wall, a flange (111) and an outer thread (112). The cross-section of the pintle (11) may be non-circular. The front end of the pintle (11) is mounted rotatably in the mounting cavity (25) in the frame (21). The flange (111) is formed on and protrudes radially from the outer wall of the pintle (11) near the rear end of the pintle (11). The outer thread (112) is formed on the front end of the pintle (11).

The base disk (12) is mounted securely on the rear side of the frame (21) and has two opposite sides, a mounting hole (121), multiple positioning holes (122), multiple securing holes (123), a curved limiting slot (124) and multiple screws. The mounting hole (121) is formed through the base disk (12) and is mounted rotatably around the pintle (11). The positioning holes (122) are formed through the base disk (12) concentrically around the mounting hole (121) in the base disk (12) at intervals and may be paired in couples. The positioning holes (122) of each couple are diametrically opposite to each other. The securing holes (123) are formed through the base disk (12) and correspond respectively to the securing holes (24) in the frame (21). The curved limiting slot (124) is formed through the base disk (12) concentrically around the positioning holes (122). The screws are respectively and sequentially mounted through the securing holes (122) in the base disk (12) and the securing holes (24) in the frame (21) to mounted the base disk (12) securely on the rear side of the frame (21).

The first positioning disk (13) abuts a first side of the base disk (12), has a limiting hole (131) and at least one first protrusion (132) and may be implemented in several ways. The limiting hole (131) is formed through the first positioning disk (13) and is mounted securely around the pintle (11), so that the first positioning disk (13) can rotate relative to the base disk (12). The limiting hole (131) may be non-circular and corresponds to the cross-section of the pintle (11) to hold the first positioning disk (13) securely on the pintle (11). The at least one first protrusion (132) is formed on and protrudes from the first positioning disk (13) and selectively engages with a corresponding number of the positioning holes (122) in the base disk (12). When the pintle (11) is rotated, the first positioning disk (13) is driven to rotate relative to the base disk (12), and the at least one first protrusion (132) can selectively engage with different positioning holes (122) to position the first positioning disk (13) at different positions.

In a preferable implementation of the first positioning disk (13), the first positioning disk (13) has two first protrusions (132). The first protrusions (132) are diametrically opposite to each other and selectively engage with one of the couples of the positioning holes (122) in the base disk (12).

The second positioning disk (16) abuts a second side of the base disk (12), has a limiting hole (161) and at least one second protrusion (162) and may be implemented in several ways. The limiting hole (161) is formed through the second positioning disk (16) and is mounted securely around the pintle (11), so that the second positioning disk (16) can rotate relative to the base disk (12). The limiting hole (161) may be non-circular and corresponds to the cross-section of the pintle (11) to hold the second positioning disk (16) securely on the pintle (11). The at least one second protrusion (162) is formed on and protrudes from the second positioning disk (16), selectively engages with a corresponding number of the positioning holes (122) in the base disk (12) and is offset relative to the at least one first protrusion (132) on the first positioning disk (13). When the pintle (11) is rotated, the second positioning disk (16) is driven to rotate relative to the base disk (12), and the at least one second protrusion (162) can selectively engage with different positioning holes (122) to position the second positioning disk (16) at different positions.

With further reference to FIG. 2, in a preferable implementation of the second positioning disk (16), the second positioning disk (16) has two second protrusions (162). The second protrusions (162) are diametrically opposite to each other and selectively engage with one of the couples of the positioning holes (122) in the base disk (12). Wherein, an included angle between any one of the first protrusions (132) and any one of the second protrusions (162) is not a multiple of that between adjacent two positioning holes (122), i.e. the former one is a non-integer multiple of the later one. Thus, when the first protrusions (132) engage with the positioning holes (122), the second protrusions (162) are offset relative to the positioning holes (122). Accordingly, with the characteristic arrangement of the first protrusions (132) and the second protrusions (162), the first positioning disk (13) and the second positioning disk (16) can be respectively held at different positions which have double number of the positioning holes (122) to improve the adjustability of the hinge (10).

The at least one spacer (14) is mounted around the pintle (11) to provide compressive resilience. When the at least one first protrusion (132) does not engages with the positioning holes (122), the first positioning disk (13) and the base disk (12) are pushed away from each other to compress the at least one spacer (14).

The limiting member (17) has a limiting hole (171) and a curved limiting lip (172). The limiting hole (171) is formed through the limiting member (17) and is mounted securely around the pintle (11). The limiting hole (171) may be non-circular and corresponds to the cross-section of the pintle (11). The curved limiting lip (172) is formed on and protrudes transversely from the limiting member (17) and is inserted into the curved limiting slot (124) in the base disk (12). So, the rotation range of the limiting member (17) is limited with the curved limiting slot (124).

The fastener (15) is mounted on the front end of the pintle (11) to hold the base disk (12), the first positioning disk (13), the at least one spacer (14) and the optional second positioning disk (16) and limiting member (17) on the pintle (11) against the flange (111) of the pintle (11). The fastener (15) may be a nut screwed onto the outer thread (112) of the front end of the pintle (11).

The supporting stem (23) has a proximal end, a distal end and a driving hole. The proximal end of the supporting stem (23) is attached securely to the rear end of the pintle (11). The driving hole is formed in the proximal end of the supporting stem (23) and may be non-circular and correspond to the cross-section of the pintle (11) to securely holds the rear end of the pintle (11) to mount the proximal end of the supporting stem (23) securely on the rear end of the pintle (11).

Relative rotation between the pintle (11) and the base disk (12) allows the supporting stem (23) to rotate relative to the frame (21), and the distal end of the supporting stem (23) can rotate along a circular route parallel to the frame, i.e. the supporting stem (23) can rotate at an axis of the pintle (11). Further, because the at least one first protrusion (132) on the first positioning disk (13) can selectively engage with different positioning holes (122) in the base disk (12), the supporting stem (23) can be positioned at multiple stay positions. Depending on different stay positions at which the supporting stem (23) stays, a magnitude of an included angle between the supporting stem (23) and the frame (21) is different. The screen (22) on the frame (21) can be adjusted to incline at a desired angle of view to display the digital images by holding the supporting stem (23) at a specific stay position.

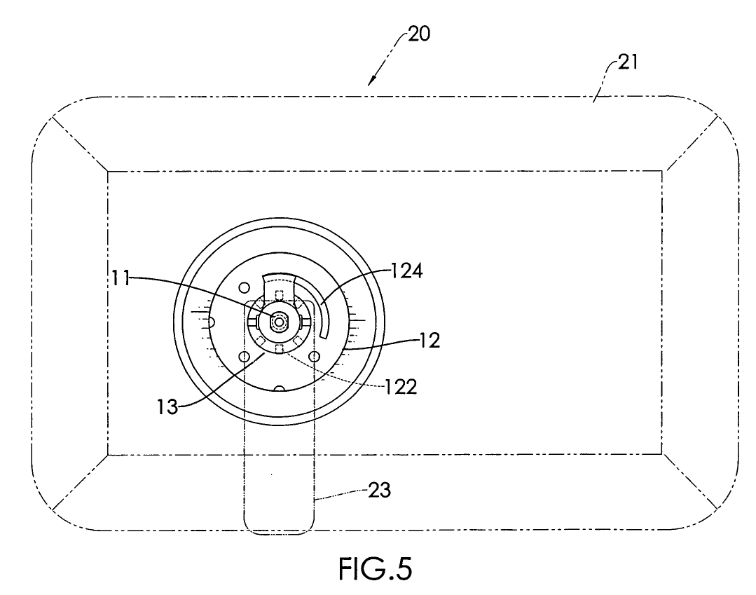

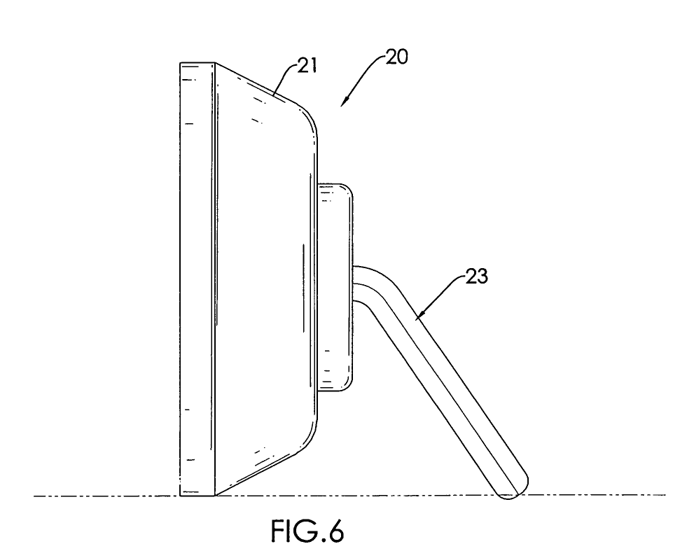

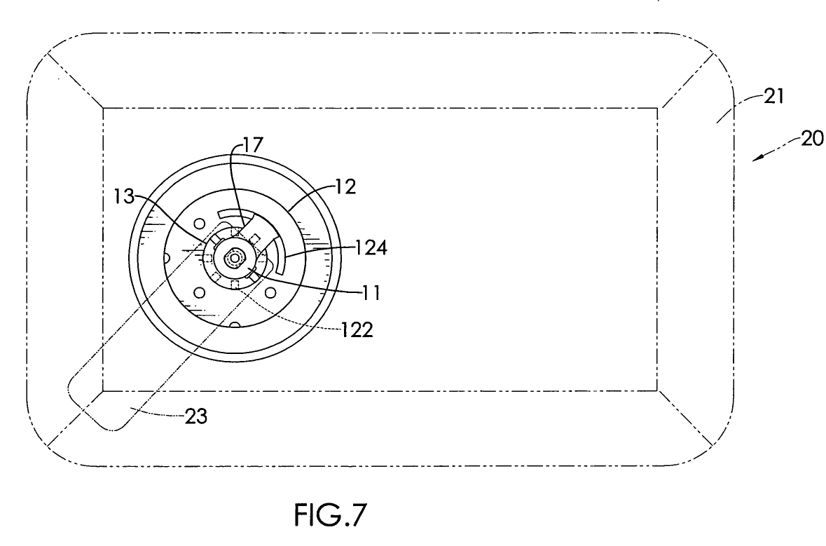

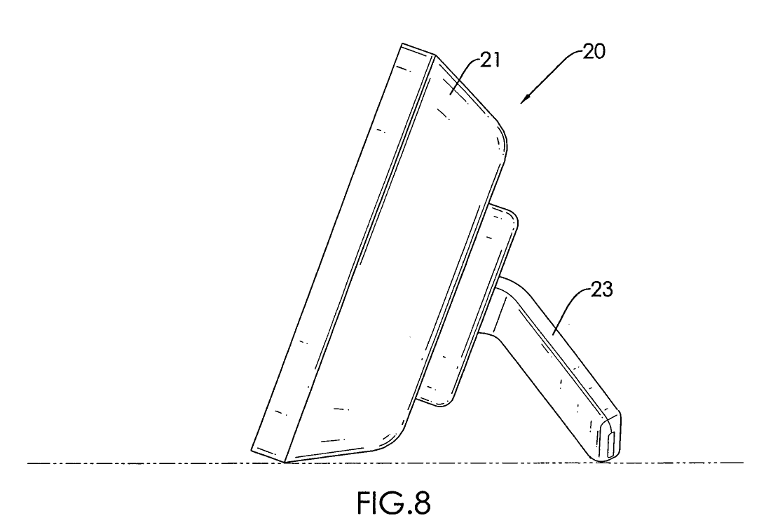

With reference to FIG. 5, the supporting stem (23) is held at a stay position toward six o'clock and, with further reference to FIG. 6, an included angle between the supporting stem (23) and the frame (21) erects the electronic photo frame (20) uprightly. With reference to FIG. 7, the supporting stem (23) is held at a stay position toward 7 o'clock, with further reference to FIG. 8, an included angle between the supporting stem (23) and the frame (21) is larger than that shown in FIG. 6 and erects the electronic photo frame (20) at an inclined angle.

Additionally, because the distal end of the supporting stem (23) can rotate along the circular route parallel to the frame (21), the supporting stem (23) can be selectively rotated toward the short edges or the long edges of the frame (21) to erect the electronic photo frame (20) in vertical type or horizontal type.

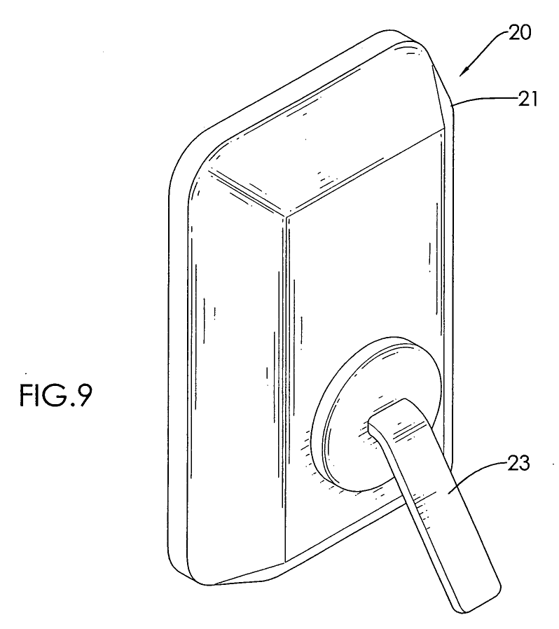

With reference to FIG. 3, the supporting stem (23) is rotated toward a long edge of the frame (21), so that the electronic photo frame (20) can stand on a flat surface with the supporting stem (23) and the long edge of the frame (21) to be erected in a horizontal type. With further reference to FIG. 9, the supporting stem (23) is rotated toward a short edge of the frame (21), so that the electronic photo frame (20) can stand on a flat surface with the supporting stem (23) and the short edge of the frame (21) to be erected in a vertical type.

Further, because the curved limiting lip (172) on the limiting member (17) is held in the curved limiting slot (124) in the base disk (12), the supporting stem (23) is limited to rotate within the angle of the curved limiting slot (124).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge comprising
a pintle having
a cross-section;
a front end;
a rear end;
an outer wall; and
a flange formed on and protruding radially from the outer wall of the pintle near the rear end of the pintle;
a base disk having
two opposite sides;
a mounting hole formed through the base disk and mounted rotatably around the pintle; and
multiple positioning holes formed through the base disk concentrically around the mounting hole in the base disk at intervals;
a first positioning disk abutting a first side of the base disk and having
a limiting hole formed through the first positioning disk and mounted securely around the pintle; and
at least one first protrusion formed on and protruding from the first positioning disk and selectively engaging with a corresponding number of the positioning holes in the base disk;
at least one spacer mounted around the pintle; and
a fastener mounted on the front end of the pintle to hold the base disk, the first positioning disk and the at least one spacer on the pintle against the flange of the pintle.

2. The hinge as claimed in claim 1, wherein the hinge further has a second positioning disk abutting a second side of the base disk and having
a limiting hole formed through the second positioning disk and mounted securely around the pintle; and
at least one second protrusion formed on and protruding from the second positioning disk, selectively engaging with a corresponding number of the positioning holes in the base disk and being offset relative to the at least one first protrusion on the first positioning disk.

3. The hinge as claimed in claim 2, wherein
the positioning holes in the base disk are paired in couples, and the positioning holes of each couple are diametrically opposite to each other;
the first positioning disk has two first protrusions diametrically opposite to each other and selectively engaging with one of the couples of the positioning holes in the base disk; and
the second positioning disk has two second protrusions diametrically opposite to each other and selectively engaging with one of the couples or the positioning holes in the base disk.

4. The hinge as claimed in claim 3, wherein an included angle between any one of the first protrusions and any one of the second protrusions is a non-integer multiple of that between adjacent two positioning holes.

5. The hinge as claimed in claim 1, wherein
the base disk further has a curved limiting slot formed through the base disk concentrically around the positioning holes; and
the hinge further has a limiting member having
a limiting hole formed through the limiting member and mounted securely around the pintle; and
a curved limiting lip formed on and protruding transversely from the limiting member and inserted into the curved limiting slot in the base disk.

6. The hinge as claimed in claim 1, wherein
the pintle further has an outer thread formed on the front end of the pintle; and
the fastener is a nut screwed onto the outer thread of the front end of the pintle.
